(19) United States
(12) Patent Application Publication
(10) Pub. No.: US 2015/0110925 A1
(43) Pub. Date: Apr. 23, 2015

(54) LOW-CALORIE BEVERAGE COMPOSITION

(71) Applicant: SAMSUNG FINE CHEMICALS CO., LTD., Ulsan (KR)

(72) Inventors: Hyun Woo LEE, Incheon (KR); Eun Jung LEE, Seoul (KR); Jae Ho LEE, Seongnam-si (KR)

(21) Appl. No.: 14/505,960

(22) Filed: Oct. 3, 2014

(30) Foreign Application Priority Data
Oct. 17, 2013 (KR) 10-2013-0124167

(51) Int. Cl. A23L 2/60

(52) U.S. Cl. CPC A23L 2/60; A23V 2002/00
USPC 426/72; 426/590; 426/580; 426/592; 426/593; 426/594; 426/598; 426/599; 426/548

(57) ABSTRACT

Disclosed is a beverage composition. The beverage composition includes a sweetener and cellulose ether. Accordingly, the beverage composition provides a strong sweet taste with low levels of unpleasant tastes or residual tastes, and satisfactory body-viscosity.

### RELATED APPLICATION

This application claims the benefit of Korean Patent Application No. 10-2013-0124167, filed on Oct. 17, 2013, in the Korean Intellectual Property Office, the disclosure of which is incorporated herein in its entirety by reference.

### BACKGROUND

1. Field

One or more embodiments of the present invention relate to a low-calorie beverage composition, and more particularly, to a low-calorie beverage composition in which a sweetener and cellulose ether are included for obtaining strong sweetness, a low caloric value, low intensity of unpleasant tastes or residual tastes, and improved body-viscosity.

2. Description of the Related Art

The sweetness of most sweeteners is about several ten to several hundred times the sweetness of sugar (sucrose), and thus, even in a small amount, sweeteners may effectively have sweetness. Although sweeteners substantially help to reduce calorie intake, they have a problem of generating a metallic taste or other various residual tastes, thus causing customers to avoid drinking sweetener-containing beverages.

Various kinds of artificial or natural sweeteners are currently available in the market. Examples of artificial sweeteners include aspartame and acesulfame potassium, and examples of natural sweeteners include stevioside, enzymatically-modified stevia (glucosyl stevia), and rebaudioside A.

Generally, carbonated drinks contain sugar, fructose, glucose, etc., and have an average caloric value of about 40 kcal/100 ml. Accordingly, people who consume carbonated drinks may consequently take in about 10 wt % sugar solutions, and due to this and the westernized dietary habit of taking in a larger large amount of sugar, people may consume an excessive amount of sugar and may eventually have adult diseases such as obesity or diabetes.

As a result, various kinds of zero-calorie beverages using sweeteners have been favored, and most of such zero-calorie beverages contain sweeteners. However, many consumers know the taste difference between general beverages and zero-calorie beverages and dislike the unpleasant tastes or residual tastes of such beverages. Thus, many consumers are not willing to purchase zero-calorie beverages. In fact, the low-calorie beverage market accounts for about 30% of the entire carbonated drinks market in terms of sales but its growth rate is very sluggish. Therefore, mid-calorie beverages have recently been introduced. Mid-calorie beverages refer to beverages having improved tastes and manufactured using sweeteners together with conventional sugars. An example of the mid-calorie beverages is low-calorie milk.

Various attempts have been made to mask the unpleasant tastes and residual tastes of sweeteners. For example, a method of using cyclodextrin or crystalline fructose to mask the unpleasant tastes or residual tastes of sweeteners has been attempted. However, the method is not applicable to zero-calorie beverages.

### SUMMARY

One or more embodiments of the present invention provide a beverage composition including a sweetener and cellulose ether.

Additional aspects will be set forth in part in the description which follows and, in part, will be apparent from the description, or may be learned by practice of the presented embodiments.

According to one or more embodiments of the present invention, a beverage composition includes water, a main material, a sweetener having a sweetness of 40 or higher, and cellulose ether.

The content of the water may be in the range of 90 parts by weight to 99.97 parts by weight, for example, 97.5 parts by weight to 99.97 parts by weight, based on 100 parts by weight of the beverage composition.

The main material may include carbonic acid, an alcohol, a fruit juice, a milk component, a dietary fiber, a coloring agent, a flavoring agent, citric acid, a coffee component, a vitamin, a soymilk component, a chocolate component, a plant extract, or a combination thereof.

The content of the main material may be in the range of 0.01 parts by weight to 10 parts by weight based on 100 parts by weight of the beverage composition.

The sweetener may include at least one compound selected from the group consisting of: artificial sweeteners including aspartame, acesulfame potassium, Neohesperidin DC, neotame, saccharin, sucralose, alitame, thaumatin, cyclamate, glycyrrhizin, or a combination thereof; and natural sweeteners including stevioside, enzymatically-modified stevia, rebaudioside A or a combination thereof.

The content of the sweetener may be in the range of 0.01 parts by weight to 0.5 parts by weight based on 100 parts by weight of the beverage composition.

The cellulose ether may include hydroxypropyl methyl cellulose (HPMC), methyl cellulose (MC), carboxymethyl cellulose (CMC), or a combination thereof.

The HPMC may include 4 wt % to 12 wt % of a hydroxypropoxy group and 19 wt % to 30 wt % of a methoxy group, and the HPMC may have a viscosity of 3 cps to 100,000 cps.

The content of the cellulose ether may be in the range of 0.01 parts by weight to 2 parts by weight based on 100 parts by weight of the beverage composition.

The beverage composition may have a caloric value of 40 kcal/100 ml or less.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

A beverage composition will now be described in detail according to an embodiment of the present invention.

The beverage composition according to the embodiment of the present invention includes water, a main material, a sweetener having a sweetness of 40 or higher, and cellulose ether. Herein, the term “sweetness of the sweetener” is defined as the sweetness of an aqueous solution of the sweetener having the same concentration as that of an aqueous sucrose solution having a predetermined concentration , provided that the sweetness of the aqueous sucrose solution is assumed as 1. The sweetness of the sweetener is determined by a sensory method in which the sweetener is gradually diluted with water until the sweetener diluted with water tastes as having the same sweetness as an aqueous sucrose solution having the predetermined concentration.

The content of the water is an amount to make the total content of the beverage composition be 100 parts by weight. Specifically, the content of the water may be in the range of 90 parts by weight to 99.97 parts by weight, for example, 97.5 parts by weight to 99.97 parts by weight, based on 100 parts by weight of the beverage composition.

The main material may include carbonic acid, an alcohol, a fruit juice, a milk component, a dietary fiber, a coloring agent, a flavoring agent, citric acid, a coffee component, a vitamin, a soymilk component, a chocolate component, a plant extract, or a combination thereof.

The plant extract may include an unpolished rice extract, a green tea extract, a black tea extract, a pinus sylvestris extract, a malt extract, or a combination thereof.

The milk component may be derived from at least one kind of milk powder selected from the group consisting of whole milk powder, skim milk powder, and sweet whey powder.

The dietary fiber may include at least one selected from the group consisting of fiber sols, chicory dietary fiber, oat dietary fiber, wheat dietary fiber, bean dietary fiber, psyllium husks, barley dietary fiber, sugar cane dietary fiber, gums, and fructooligosaccharides.

The coloring agent may include at least one selected from the group consisting of: tar-containing colorants such as Food Green No. 3, Food Red No. 2, Food Red No. 3, Food Blue No. 1, Food Blue No. 2, Food Yellow No. 4, and Food Yellow No. 5 stated in the Korean Food Additive Codex; and tar-free colorants such as β-carotene, water-soluble annatto, copper sulfates, ferric oxide, caramel, sodium copper chlorophyllin, sodium iron chlorophyllin, and titanium oxides.

The flavoring agent may include at least one selected from the group consisting of fruit flavors, fermented milk flavors, cream flavors, and milk flavors.

The content of the main material may be in the range of 0.01 parts by weight to 10 parts by weight based on 100 parts by weight of the beverage composition. If the content of the main material is within the above range, the taste of the main material may be sufficiently felt by consumers, and consumers may easily take in the beverage composition.

The sweetness of the sweetener may be, for example, in the range of 100 to 4,000.

The sweetener may be an artificial sweetener or a natural sweetener.

The artificial sweetener may include aspartame, acesulfame potassium, Neohesperidin DC, neotame, saccharin, sucralose, alitame, thaumatin, cyclamate, glycyrrhizin, or a combination thereof.

The natural sweetener may include stevioside, enzymatically-modified stevia, rebaudioside A, or a combination thereof.

The content of the sweetener may be in the range of 0.01 parts by weight to 0.5 parts by weight based on 100 parts by weight of the beverage composition. If the sweetener content is within the above range, the beverage composition may provide sufficient sweetness and may be inexpensive and economical in terms of the sweetener cost.

The cellulose ether may include hydroxypropyl methyl cellulose (HPMC), methyl cellulose (MC), carboxymethyl cellulose (CMC), or a combination thereof. The cellulose ether masks unpleasant tastes or residual tastes caused by the sweetener.

The HPMC may have a hydroxypropoxy group content in the range of 4 wt % to 12 wt % (e.g., 4 wt % to 7.5 wt %), a methoxy group content in the range of 19 wt % to 30 wt % (e.g., 27 wt % to 30 wt %), and may have a viscosity of 3 cps to 100,000 cps (e.g., 3 cps to 15 cps). Herein, “the hydroxypropoxy group content” and “the methoxy group content” each refer to a weight ratio of the substituent to the HPMC. Herein, “the viscosity of HPMC” is a value measured, as stated in articles about medicines in the Korean Pharmacopoeia, by using a Brookfield LV viscometer, and setting the spindle number and number of revolution of a spindle that are suitable for a certain level of viscosity, performing an operation of (i) reading a viscosity value after rotating the spindle for two minutes and (ii) stopping the spindle for two minutes, repeating the operation three times total, and calculating the average of three viscosity values. The viscosity of the HPMC is referred to as the viscosity of a 2 wt % aqueous HPMC solution.

The CMC may be used in the form of sodium carboxymethyl cellulose.

The content of the cellulose ether may be in the range of 0.01 parts by weight to 2 parts by weight based on 100 parts by weight of the beverage composition. If the content of the cellulose ether is within the above range, the inherent taste of the main material may be maintained while unpleasant tastes or residual tastes caused by the sweetener are effectively masked.

The beverage composition may have a caloric value of 40 kcal/100 ml or less. For example, the beverage composition may have a caloric value of 0.1 kcal/100 ml to 5 kcal/100 ml.

Hereinafter, the present invention will be described in more detail through examples. However, the present invention is not limited to the examples.

### EXAMPLES

### Examples 1 to 8 and Comparative Examples 1 to 2

### Preparation of Beverage Compositions

(1) Preparation of Aqueous HPMC Solutions

10.0 g of each HPMC shown in Table 1 below was put into a 500 mL beaker. Next, after additionally adding 250 g of 80° C. water to the beaker, the contents of the beaker were stirred using a stirrer at 230 rpm for 30 minutes. Then, room-temperature water was added thereto until the weight of the contents of the beaker became 500 g. In this way, a 2 wt % aqueous HPMC solution was prepared. Thereafter, the contents of the beaker were stirred using a stirrer at 230 rpm for 30 minutes and then naturally cooled down.

TABLE 1

| | Types of HPMC used |
|---|---|
| Example 1 | HPMC 2910 50 cps |
| | (Samsung Fine Chemicals Co., Ltd., AnyAddy ® |
| | A11) |
| Example 2 | HPMC 2906 50 cps |
| | (Samsung Fine Chemicals Co., Ltd., AnyAddy ® |
| | B42) |
| Examples 3 & 5 to 7 | HPMC 2208 50 cps |
| | (Samsung Fine Chemicals Co., Ltd., AnyAddy ® |
| | C89) |
| Examples 4 & 8 | HPMC 2208 100 cps |
| | (Samsung Fine Chemicals Co., Ltd., AnyAddy ® |
| | C42) |
| Comparative | No HPMC was added |
| examples 1 & 2 | |

(2) Preparation of Beverage Compositions

Refined sugar, a sweetener (Daepyung Co., Ltd., enzymatically-modified stevia), the aqueous HPMC solutions prepared in Preparation (1), and purified water were mixed at ratios shown in Table 2 and stirred at room temperature (about 25° C.) using a stirrer at 300 rpm for 30 minutes. As a result, beverage compositions were obtained. Since the effect of adding the sweetener and cellulose ether could be confirmed without adding a main material, the main material was not added to the beverage compositions.

TABLE 2

| | Contents (parts by weight) | | | | | | | | | |
|---|---|---|---|---|---|---|---|---|---|---|
| | | | | | | | | | Comparative | |
| Raw | Examples | | | | | | | | Examples | |
| Materials | 1 | 2 | 3 | 4 | 5 | 6 | 7 | 8 | 1 | 2 |
| Refined | 0 | 0 | 0 | 0 | 0 | 0 | 0 | 0 | 5 | 0 |
| Sugar | | | | | | | | | | |
| Sweetener | 0.05 | 0.05 | 0.05 | 0.05 | 0.05 | 0.05 | 0.05 | 0.05 | 0 | 0.05 |
| A11 2 wt % | 7.5 | 0 | 0 | 0 | 0 | 0 | 0 | 0 | 0 | 0 |
| aqueous sol. | | | | | | | | | | |
| B42 2 wt % | 0 | 7.5 | 0 | 0 | 0 | 0 | 0 | 0 | 0 | 0 |
| aqueous sol. | | | | | | | | | | |
| C89 2 wt % | 0 | 0 | 7.5 | 0 | 15 | 25 | 50 | 0 | 0 | 0 |
| aqueous sol. | | | | | | | | | | |
| C42 2 wt % | 0 | 0 | 0 | 7.5 | 0 | 0 | 0 | 15 | 0 | 0 |
| aqueous sol. | | | | | | | | | | |
| Purified | 92.45 | 92.45 | 92.45 | 92.45 | 84.95 | 74.95 | 49.95 | 84.95 | 95 | 99.95 |
| Water | | | | | | | | | | |
| Total | 100 | 100 | 100 | 100 | 100 | 100 | 100 | 100 | 100 | 100 |

### EVALUATION EXAMPLE

### Evaluation Example 1

### Evaluation of Physical Properties of Beverage Compositions using 5-Point Rating Scale

The beverage compositions prepared in Examples 1 to 8 and Comparative Examples 1 to 2 were evaluated regarding their unpleasant taste intensity, sweet taste intensity, and body-viscosity as described below. The results are shown in Table 4 below. In this specification, “body-viscosity” refers to weight feeling or texture feeling perceived within the entire mouth.

(Evaluation Method)

(1) Evaluation Panel: 10 persons (trained personnel for sensory test)

(2) Evaluation Method:

A sensory test for evaluating the unpleasant taste intensity, sweet taste intensity, and body-viscosity of each of the beverage compositions was performed by a method described below. More specifically, the sensory test was performed within 10 minutes after preparing the beverage compositions. In particular, the sensory test was performed based on a 5-point rating scale: i.e., very bad (1 point), bad (2 points), normal (3 points), good (4 points), and very good (5 points).

### Evaluation Example 2

### Evaluation of Caloric Values of Beverage Compositions

Each of the beverage compositions was examined regarding its caloric value as described below and the results are shown in Table 4 below. Specifically, the caloric value of each of the beverage compositions was calculated using Atwater index. Here, a calorie nutrient generates different amounts of heat between when burning in a calorimeter and when burning in the human body. In a calorimeter, carbohydrates generate a caloric value of 4.1 kcal per 1 g, fats generate a caloric value of 9.45 kcal per 1 g, and proteins generate a caloric value of 5.65 kcal per 1 g. However, when being absorbed in the human body, only 98% of carbohydrates, only 95% of fats, and only 92% of proteins are absorbed therein on average. Therefore, the actual caloric value generated by nutrient intake are 4 kcal per 1 g of carbohydrates, 9 kcal per 1 g of fats, and 4 kcal per 1 g of proteins. Table 3 below shows general nutrient compositions per 100 g of each of the refined Sugar, the sweetener (enzymatically-modified stevia), and the HPMC. The caloric value shown in Table 4 were calculated based on the data shown in Table 3.

TABLE 3

| | | |
|---|---|---|
| Refined Sugar | Sweetener | HPMC |

| | | | | | | |
|---|---|---|---|---|---|---|
| Carbohydrates | 100 | g | 70.5 | g | 100 | g |
| Fats | 0 | g | 14.2 | g | 0 | g |
| Proteins | 0 | g | 2 | g | 0 | g |
| Total | 100 | g | 86.7 | g*** | 100 | g |

***The sweetener includes 13.3 g of non-nutrients per 100 g.

TABLE 4

| | | | | | | | | | Comparative | |
|---|---|---|---|---|---|---|---|---|---|---|
| | Examples | | | | | | | | Examples | |
| Physical Properties | 1 | 2 | 3 | 4 | 5 | 6 | 7 | 8 | 1 | 2 |
| Unpleasant Taste Intensity | 3.8 | 4.2 | 3.5 | 3.2 | 3.3 | 2.4 | 2.2 | 2.3 | 1.0 | 5.0 |
| Sweet Taste Intensity | 3.9 | 4.1 | 4.0 | 3.9 | 3.8 | 3.5 | 3.3 | 3.6 | 4.0 | 4.2 |
| Body-viscosity | 3.0 | 3.1 | 2.9 | 3.2 | 3.5 | 3.8 | 4.5 | 3.7 | 3.5 | 1.0 |
| Caloric value (kcal/100 mL) | 0.8 | 0.8 | 0.8 | 0.8 | 1.4 | 2.2 | 4.2 | 1.4 | 20 | 0.2 |

Referring to Table 4, the HPMC-containing beverage compositions (containing a sweetener) prepared in Examples 1 to 8 have low degrees of unpleasant taste intensity, almost equivalent degrees of sweetness intensity, and high degrees of body-viscosity as compared to the HPMC-free beverage compositions (containing a sweetener) prepared in Comparative Example 2. The beverage composition (containing refined sugar) prepared in Comparative Example 1 has a low degree of unpleasant taste intensity, a high degree of sweetness intensity, and a high degree of body-viscosity, but has problems such as high production costs and a high caloric value due to a high content of refined sugar.

As described above, according to the embodiment of the present invention, since the beverage composition includes the sweetener and cellulose ether, the beverage composition has a strong sweet taste, a low caloric value, low intensity of unpleasant or residual tastes, and improved body-viscosity, and thus consumers may easily take in the beverage composition.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments of the present invention have been described, it will be understood by those of ordinary skill in the art that various changes in form and details may be made therein without departing from the spirit and scope of the present invention as defined by the following claims.

What is claimed is:

1. A beverage composition comprising water, a main material, a sweetener having a sweetness of 40 or higher, and cellulose ether.

2. The beverage composition of claim 1, wherein the main material comprises carbonic acid, an alcohol, a fruit juice, a milk component, a dietary fiber, a coloring agent, a flavoring agent, citric acid, a coffee component, a vitamin, a soymilk component, a chocolate component, a plant extract, or a combination thereof, and the content of the main material is in the range of 0.01 parts by weight to 10 parts by weight based on 100 parts by weight of the beverage composition.

3. The beverage composition of claim 1, wherein the sweetener comprises at least one compound selected from the group consisting of: artificial sweeteners comprising aspartame, acesulfame potassium, Neohesperidin DC, neotame, saccharin, sucralose, alitame, thaumatin, cyclamate, glycyrrhizin, or a combination thereof; and
natural sweeteners comprising stevioside, enzymatically-modified stevia, rebaudioside A, or a combination thereof.

4. The beverage composition of claim 1, wherein the content of the sweetener is in the range of 0.01 parts by weight to 0.5 parts by weight based on 100 parts by weight of the beverage composition.

5. The beverage composition of claim 1, wherein the cellulose ether comprises hydroxypropyl methyl cellulose (HPMC), methyl cellulose (MC), carboxymethyl cellulose (CMC), or a combination thereof.

6. The beverage composition of claim 5, wherein the HPMC comprises 4 wt % to 12 wt % of a hydroxypropoxy group and 19 wt % to 30 wt % of a methoxy group and has a viscosity of 3 cps to 100,000 cps.

7. The beverage composition of claim 1, wherein the content of the cellulose ether is in the range of 0.01 parts by weight to 2 parts by weight based on 100 parts by weight of the beverage composition.

8. The beverage composition of claim 1, wherein the beverage composition has a caloric value of 40 kcal/100 ml or less.
